(19) United States
(12) Patent Application Publication
(10) Pub. No.: US 2024/0274027 A1
(43) Pub. Date: Aug. 15, 2024

(54) SEAT SUPPORT MECHANISM OF DRIVING SIMULATOR FOR 4-WHEELED AUTOMOBILE

(71) Applicants: IROC CO.,LTD. SUGIURA CO.,LTD., Nagoya-shi, Aichi (JP); SUGIURA CO., LTD., Okazaki-shi, Aichi, (JP)

(72) Inventor: Takuma KOGA, Nagoya-shi (JP)

(73) Assignees: IROC CO.,LTD. SUGIURA CO.,LTD., Nagoya-shi, Aichi (JP); SUGIURA CO., LTD., Okazaki-shi, Aichi, (JP)

(21) Appl. No.: 18/681,033

(22) PCT Filed: Mar. 7, 2023
(86) PCT No.: PCT/JP2022/009618

§ 371 Date: Feb. 2, 2024

(30) Foreign Application Priority Data
Dec. 28, 2021 (JP) 2021-214386

(51) Int. Cl. G09B 9/04

(52) U.S. Cl. CPC G09B 9/04

(57) ABSTRACT

A seat support mechanism (1) for a four-wheel vehicle driving simulator includes: a base (2) placed on a ground; a seat support base (5) with a seat (3) being fixed, a pair of cylinder type actuators (6) that connects the base (2) and the seat support base (5) at two front positions of the seat support base (5) to have a gap therebetween, and has both end portions as universal joints; a pair of hydraulic dampers (7) that connects the base (2) and the seat support base (5) at two back positions of the seat support base (5) to have a gap therebetween, and has both end portions as universal joints; and a ball joint (9) that connects the base (2) and the seat support base (5) at a central portion of the seat support base (5) to have a gap therebetween.

### CROSS-REFERENCE TO RELATED APPLICATIONS

The present application is based on Japanese Patent Application No. 2021-214386 filed on Dec. 28, 2021, the contents of which are incorporated herein by reference.

### TECHNICAL FIELD

The present disclosure relates to a seat support mechanism for a four-wheel vehicle driving simulator, particularly to a seat support mechanism for a four-wheel vehicle driving simulator that improves responsiveness to seat forward tilting during reproduction of braking or the like.

### BACKGROUND ART

Conventionally, as a seat support mechanism for a four-wheel vehicle driving simulator, there has been known a seat support mechanism including a base placed on a ground, a seat support base with a seat being fixed, and a pair of cylinder type actuators that connects the base and the seat support base at two back positions of the seat support base to have a gap therebetween, and has both end portions as universal joints (see Patent Literature 1).

However, in such a seat support mechanism, it is required to push up rods of the cylinder type actuators against gravity when the seat is tilted forward during reproduction of braking or the like, and there has been a problem in the responsiveness.

In the configuration of the seat support mechanism of Patent Literature 1, since a rotation center of the seat support base is located considerably on a front side from the seat position, a considerable amount of rod extension is required to realize a desired seat forward tilting angle.

Therefore, as a countermeasure, there is also a configuration including a plurality of pairs of cylinder type actuators (see Patent Literature 2). In a case of such a configuration, it is possible to obtain a certain effect on responsiveness to seat forward tilting by causing the pairs of cylinder type actuators to cooperate with each other.

However, even with such a configuration, it is required to push up the rods of the cylinder type actuators against gravity when the seat is tilted forward, and there are many cases where a cooperation condition is easily changed due to a difference in a weight of a person on the seat, a seat position of the person, or the like, so that the effect is not obtained.

In the case of the configuration of Patent Literature 2, since a plurality of pairs of cylinder type actuators are provided, there is a potential problem that the size, weight, cost, power consumption, and the like of the entire apparatus inevitably increase.

### CITATIONS LIST

### Patent Literature

Patent Literature 1: JP 2000-262758 A
Patent Literature 2: JP 6618946 B2

### SUMMARY OF INVENTION

An object of the present disclosure is to provide a seat support mechanism for a four-wheel vehicle driving simulator to improve a responsiveness to seat forward tilting during reproduction of braking or the like.

In the present disclosure, a seat support mechanism for a four-wheel vehicle driving simulator includes a base placed on a ground, a seat support base with a seat being fixed, a pair of cylinder type actuators, a pair of hydraulic dampers, and a ball joint.

Here, both end portions of each of the pair of cylinder type actuators are universal joints, and the pair of cylinder type actuators connects the base and the seat support base at two front positions of the seat support base to have a gap therebetween.

And both end portions of each of the pair of hydraulic dampers are universal joints, and the pair of hydraulic dampers connects the base and the seat support base at two back positions of the seat support base to have a gap therebetween.

Further, the ball joint connects the base and the seat support base at a central portion of the seat support base to have a gap therebetween.

Here, since the pair of cylinder type actuators connects the base and the seat support base at the two front positions of the seat support base, the cylinder type actuators perform an operation of contracting a rod when realizing seat forward tilting during reproduction of braking or the like. In this case, since the cylinder type actuators can use gravity, the rod can be quickly contracted.

Therefore, the seat support mechanism for a four-wheel vehicle driving simulator of the present disclosure can improve the responsiveness to seat forward tilting during reproduction of braking or the like.

The pair of hydraulic dampers connects the base and the seat support base at the two back positions of the seat support base. Here, since the back side of the seat support base farthest from the front side of the seat support base on which the cylinder type actuator is disposed is a so-called open end portion where nothing restricts a movement beyond the seat support base, overshoot, undershoot, hunting, or the like is likely to occur with respect to a rod expansion/contraction operation of the cylinder type actuators as it is.

As a countermeasure, it is conceivable to connect the base and the seat support base with a connection bar or the like having both end portions as universal joints, but the connection bar or the like directly absorbs an impact of overshoot or the like, causing breakage of the connection bar or the like.

Then, by disposing the hydraulic dampers to connect the base and the seat support base on the back side of the seat support base, it is possible to actively attenuate an unnecessary vibration, prevent damage to the hydraulic dampers, and further stabilize operations of the seat support mechanism for a four-wheel vehicle driving simulator.

That is, the hydraulic dampers expand and contract the rod along with a vertical movement of the back side of the seat support base and attenuate and absorb the unnecessary vibration, thereby realizing the operation of a four-wheel vehicle driving simulator to have a more realistic sense.

Further, the ball joint connects the base and the seat support base at a central portion of the seat support base. Here, the ball joint can realize more smooth rotation of the seat support base as compared with the universal joint.

Therefore, the responsiveness to seat forward tilting during reproduction of braking or the like can be further improved.

### BRIEF DESCRIPTION OF DRAWINGS

The foregoing and other objects, features, and advantages of the present disclosure will become more apparent from the following detailed descriptions with reference to the accompanying drawings. The drawings are as follows.

FIG. 1 is a rear perspective view of a four-wheel vehicle driving simulator according to an exemplary embodiment.

FIG. 2 is a frame configuration diagram of a seat support mechanism for the four-wheel vehicle driving simulator according to the exemplary embodiment.

FIG. 3 is a side view of the seat support mechanism for the four-wheel vehicle driving simulator according to the exemplary embodiment.

FIG. 4 is a plan view of the seat support mechanism for the four-wheel vehicle driving simulator according to the exemplary embodiment.

FIG. 5 is a front view of the seat support mechanism for the four-wheel vehicle driving simulator according to the exemplary embodiment.

FIG. 6 is a front view of a seat support mechanism for a four-wheel vehicle driving simulator according to a modification embodiment.

FIG. 7 is a front view of a seat support mechanism for a four-wheel vehicle driving simulator according to a modification embodiment.

### DESCRIPTION OF EMBODIMENTS

### Configuration of Exemplary Embodiment

The following is a description of a mode for implementing the present disclosure based on an exemplary embodiment.

It goes without saying that the following exemplary embodiment discloses one specific example, and that the present disclosure is not limited to the following exemplary embodiment.

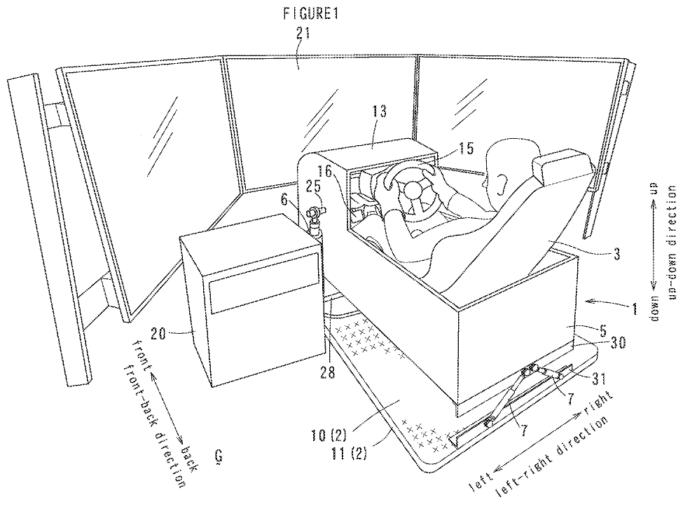

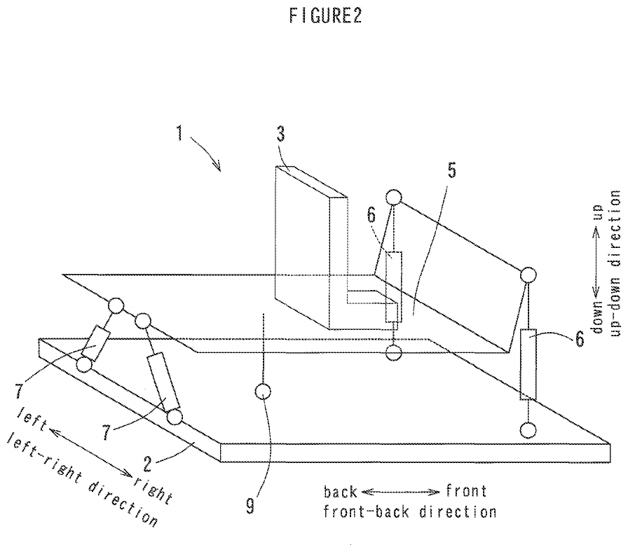

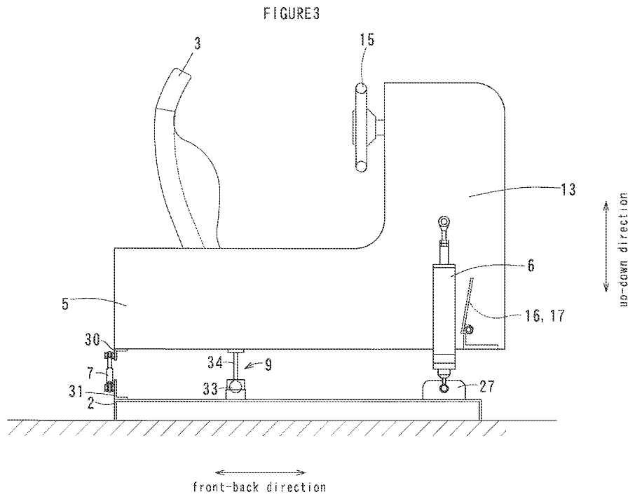

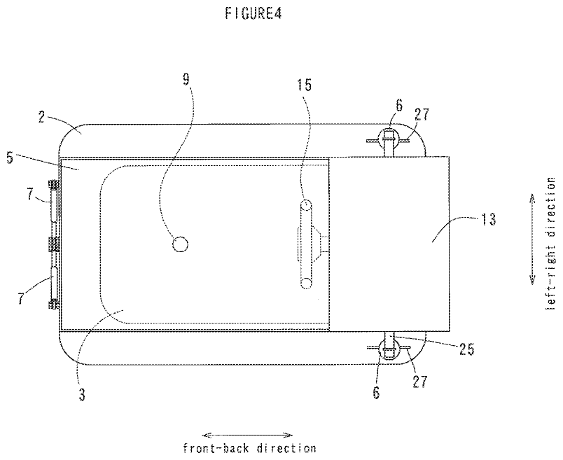

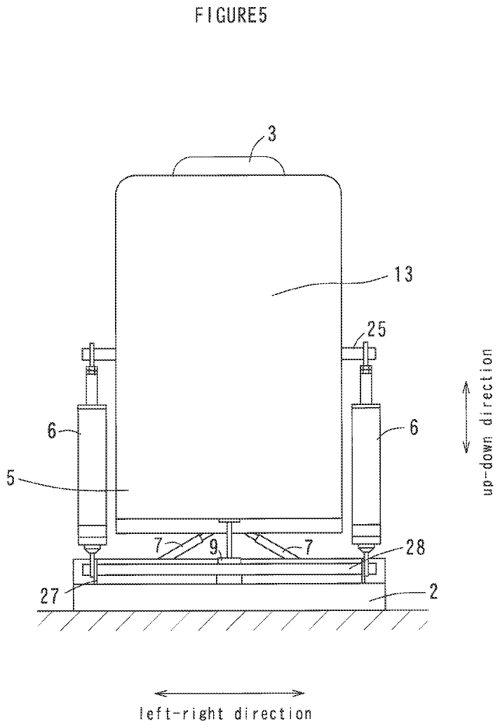

The configuration of a seat support mechanism 1 for a four-wheel vehicle driving simulator (hereinafter sometimes abbreviated as a seat support mechanism 1) according to the exemplary embodiment will be described using FIGS. 1 to 5. The seat support mechanism 1 includes a base 2 placed on a ground G, a seat support base 5 with a seat 3 being fixed, a pair of cylinder type actuators 6, a pair of hydraulic dampers 7, and a ball joint 9.

The base 2 includes a rectangular base plate 10 that is long in a front-back direction, and a rectangular frame 11 that is extended downward from an outer periphery of the base plate 10, and is symmetrically formed.

The seat support base 5 fixes the seat 3, and is rectangular box-shaped with an open top. A length of the seat support base 5 in the front-back direction is approximately equal to a length of the base 2, and a width of the seat support base 5 in a left-right direction is slightly narrower than a width of the base 2.

A hood portion 13 is formed on the front side of the seat support base 5, a handle mechanism 15 is installed in the hood portion 13, and a brake pedal 16, an accelerator pedal 17, and other units are disposed below the hood portion 13.

The seat support base 5 including the hood portion 13 is symmetrically formed.

By operating the handle mechanism 15, the brake pedal 16, the accelerator pedal 17, and the like, via a controller 20, the seat support base 5 is tilted in the front-back and left-right directions, and an image displayed on a monitor 21 installed in front thereof is changed, so that simulation of four-wheeled vehicle driving is performed.

Here, the controller 20 is configured to include a known microcomputer having a CPU with control function and calculation function, various storage devices such as a ROM and a RAM, an input device, and an output device.

Then, based on a control signal output from the controller 20, front-back or left-right tilting of the seat support base 5 is controlled, and the controller 20 outputs image information corresponding to an operation state of the seat support base 5 to the monitor 21.

When a deviation occurs between the image information of the monitor 21 and the tilting state of the seat support base 5, a great sense of discomfort is given to a person on the seat. Therefore, it is important to eliminate the deviation between the image information of the monitor 21 and the tilting state of the seat support base 5. That is, how quickly the tilting state of the seat support base 5 follows the image information instantly calculated from the operation state of the seat support base 5 is important for the four-wheel vehicle driving simulator.

Both end portions of each of the pair of cylinder type actuators 6 are universal joints, and the pair of cylinder type actuators 6 connects the base 2 and the seat support base 5 at two front positions of the seat support base 5 to have a gap therebetween.

More specifically, in each of the cylinder type actuators 6, the universal joint on the upper end portion is coupled to a bar 25 protruding in the left-right direction from a side surface of the hood portion 13, and the universal joint on the lower end portion is coupled to a bar 28 supported by a support piece 27 provided on the base 2 and extending in the left-right direction.

Since the cylinder type actuators 6 are arranged on the front side of the seat support base 5, the seat support base 5 can be tilted to the back side by extending the rod, and the seat support base 5 can be tilted to the front side by contracting the rod.

In addition, the pair of cylinder type actuators 6 is each arranged perpendicularly to the ground G and is symmetrically arranged.

Here, the symmetrical arrangement means a symmetrical arrangement including the seat support base 5 in a state of being coupled to the seat support base 5.

Both end portions of each of the pair of hydraulic dampers 7 are universal joints, and the pair of hydraulic dampers 7 connects the base 2 and the seat support base 5 at two back positions of the seat support base 5 to have a gap therebetween.

More specifically, in each of the hydraulic dampers 7, the universal joint on the upper end portion is coupled to a plate 30 extending downward from the back end of the seat support base 5, and the universal joint on the lower end portion is coupled to a plate 31 extending upward from the back end of the base 2.

Here, the pair of hydraulic dampers 7 is arranged symmetrically and is arranged to form an inverted V-shape. The symmetrical arrangement means a symmetrical arrangement including the seat support base 5 in a state of being coupled to the seat support base 5.

The hydraulic dampers 7 have a known configuration that expands and contracts the rod along with a vertical movement of the back side of the seat support base 5 and attenuates and absorbs an unnecessary vibration.

Further, the ball joint 9 connects the base 2 and the seat support base 5 at a central portion of the seat support base 5 to have a gap therebetween.

More specifically, end portions of the ball joint 9 are fixed to a lower surface of the seat support base 5 and an upper surface of the base 2 for a ball portion 33 to be on the base 2 side and for a ball stud portion 34 to be on the seat support base 5 side, and the seat support base 5 rotates about the ball portion 33 as a rotation center.

The ball joint 9 are symmetrically arranged. Here, the symmetrical arrangement means a symmetrical arrangement including the seat support base 5 in a state of being coupled to the seat support base 5.

Here, the ball joint 9 is arranged so that a projection surface of the ball joint 9 to the ground G lies within a projection surface of a rectangle formed by connecting coupling portions between the pair of cylinder type actuators 6 and the seat support base 5 and coupling portions between the pair of hydraulic dampers 7 and the seat support base 5 to the ground G.

### Effects of Exemplary Embodiment

The seat support mechanism 1 according to the exemplary embodiment includes the base 2 placed on the ground G, the seat support base 5 with the seat 3 being fixed, the pair of cylinder type actuators 6, the pair of hydraulic dampers 7, and the ball joint 9.

Here, both end portions of each of the pair of cylinder type actuators 6 are universal joints, and the pair of cylinder type actuators 6 connects the base 2 and the seat support base 5 at the two front positions of the seat support base 5 to have a gap therebetween.

Both end portions of each of the pair of hydraulic dampers 7 are universal joints, and the pair of hydraulic dampers 7 connects the base 2 and the seat support base 5 at two back positions of the seat support base 5 to have a gap therebetween.

Further, the ball joint 9 connects the base 2 and the seat support base 5 at a central portion of the seat support base 5 to have a gap therebetween.

Here, since the pair of cylinder type actuators 6 connects the base 2 and the seat support base 5 at the two front positions of the seat support base 5, the cylinder type actuators 6 perform an operation of contracting the rods when realizing seat forward tilting during reproduction of braking or the like. In this case, since the cylinder type actuators 6 can use gravity, the rods can be quickly contracted.

Therefore, the seat support mechanism 1 can improve the responsiveness to seat forward tilting during reproduction of braking or the like.

Furthermore, since the seat support mechanism 1 can improve the responsiveness to seat forward tilting during reproduction of braking or the like only by the pair of cylinder type actuators 6, the size, cost, power consumption, and the like of the entire seat support mechanism 1 can be reduced.

Here, since the seat support mechanism 1 extends the rods of the cylinder type actuators 6 against gravity when the seat is tilted backward during reproduction of acceleration or the like for a four-wheeled vehicle, there may be a concern that the responsiveness may be deteriorated. However, since four-wheeled vehicles have large inertia in the first place, rapid acceleration does not require such a steep rod change amount. Therefore, the rod extension of the cylinder type actuators 6 against gravity is sufficiently responsive.

The pair of hydraulic dampers 7 connects the base 2 and the seat support base 5 at the two back positions of the seat support base 5.

As a result, an unnecessary vibration generated on the back side of the seat support base 5 can be actively attenuated, damage of the hydraulic dampers 7 can be prevented, and operations of the seat support mechanism 1 can be further stabilized.

In addition, since the plurality of the hydraulic dampers 7 can reduce a load imposed on each of the hydraulic dampers 7, deterioration of each of the hydraulic dampers 7 can be suppressed, and a service life can be extended.

The ball joint 9 connects the base 2 and the seat support base 5 at the central portion of the seat support base 5 to have a gap therebetween.

Here, since the ball joint 9 can realize more smooth rotation of the seat support base 5 as compared with a universal joint, responsiveness to seat forward tilting during reproduction of braking or the like of the seat support base 5 can be further improved. Since the smooth rotation of the seat support base 5 can be realized by the ball joint 9, responsiveness to seat backward tilting during reproduction of acceleration or the like is also improved.

In the seat support mechanism 1 for a four-wheel vehicle driving simulator according to the exemplary embodiment, the pair of cylinder type actuators 6 is arranged perpendicularly to the ground G.

As a result, an action of gravity can be utilized maximally, and the responsiveness to seat forward tilting during reproduction of braking or the like can be further improved.

In addition, since each of the pair of cylinder type actuators 6 is arranged perpendicularly to the ground G, the projection area of the cylinder type actuators 6 to the ground G is minimized, and the three-dimensional occupied area is minimized, whereby a size of the seat support mechanism 1 can be further reduced.

In the seat support mechanism 1 according to the exemplary embodiment, the pair of cylinder type actuators 6 and the pair of hydraulic dampers 7 are symmetrically arranged.

As a result, it is possible to reduce complicatedness when assembling and complexity when controlling of the seat support mechanism 1.

In addition, at the end of energization or the like, when the pair of cylinder type actuators 6 and the pair of hydraulic dampers 7 cooperate with each other, although it depends on a position of the ball joint 9, it is possible to easily put the seat support base 5 into a state where the left and right heights are aligned in a self-consistent manner.

As a result, even when the sheet support mechanism 1 is stored for a long period of time in a non-energized state, it is possible to prevent excessive strain from accumulating in the seat support mechanism 1.

In the seat support mechanism 1 according to the exemplary embodiment, the pair of hydraulic dampers 7 is arranged to form an inverted V-shape.

This makes an arrangement configuration of the pair of hydraulic dampers 7 similar to that of an actual suspension mechanism of an automobile, and therefore, a response of the hydraulic dampers 7 accompanying a vertical movement of the back side of the seat support base 5 becomes more realistic, so that a realistic sense of the operation by the seat support mechanism 1 can be further improved.

In the seat support mechanism 1 according to the exemplary embodiment, the ball joint 9 is symmetrically arranged.

As a result, complicatedness when assembling and complexity when controlling of the seat support mechanism 1 can be further reduced, and the seat support base 5 can be easily put into a state where the left and right heights are aligned in a non-energized state or the like.

Further, the seat support mechanism 1 according to the exemplary embodiment has a configuration in which a projection surface of the ball joint 9 to the ground G lies within a projection surface of a rectangle formed by connecting coupling portions between the pair of cylinder type actuators 6 and the seat support base 5 and coupling portions between the pair of hydraulic dampers 7 and the seat support base 5 to the ground G.

As a result, since the seat support base 5 has a so-called floating configuration, the seat support base 5 rotates about the ball portion 33 of the ball joint 9 as a rotation center.

Therefore, since a desired tilting of the seat support base 5 can be realized even with a small change amount of the rods of the cylinder type actuators 6, the responsiveness to the seat forward tilting during reproduction of braking or the like can be further improved.

### Modification Embodiments

Various modification embodiments can be considered without departing from the gist of the present invention. For example, in accordance with the seat support mechanism 1 according to the exemplary embodiment, each of the pair of cylinder type actuators 6 is arranged perpendicularly to the ground G. However, the present invention is not limited to the exemplary embodiment, a configuration having an angle from a direction perpendicular to the ground G may be adopted. As a result, a degree of freedom of installing the cylinder type actuators 6 can be increased.

According to the seat support mechanism 1 of the exemplary embodiment, the ball joint 9 is arranged between the seat support base 5 and the base 2 such that the ball portion 33 is on base 2 side and the ball stud portion 34 is on seat support base 5 side. However, the ball portion 33 may be on the seat support base 5 side and the ball stud portion 34 may be on the base 2 side. Thus, the rotation center position of the seat support base 5 can be adjusted.

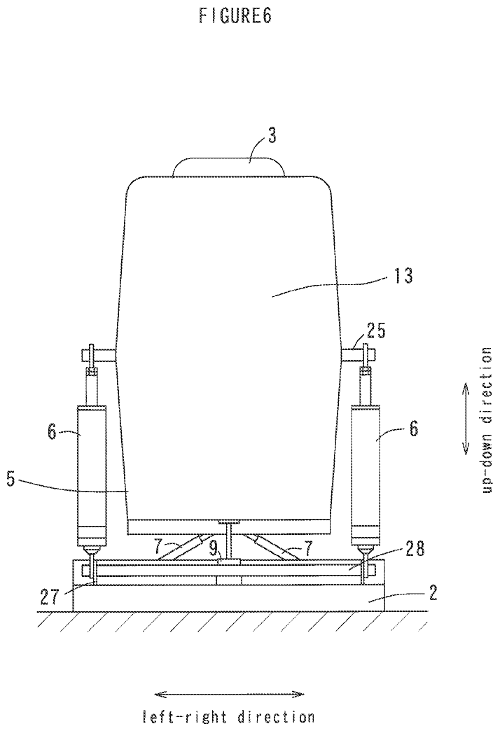

According to the seat support mechanism 1 of the exemplary embodiment, the width of the hood portion 13 in the left-right direction is substantially identical in the up-down direction. However, as illustrated in FIG. 6, the left and right side surfaces above the bar 25 of the hood portion 13 may be tapered surfaces, and the left and right side surfaces below the bar 25 may be reverse tapered surfaces.

Thus, it is possible to expand a range in which the cylinder type actuators 6 and the hood portion 13 do not interfere with each other when the seat support base 5 is tilted to the left or right side. That is, the tilting of the seat support base 5 to the left and right sides can be performed in a wider range.

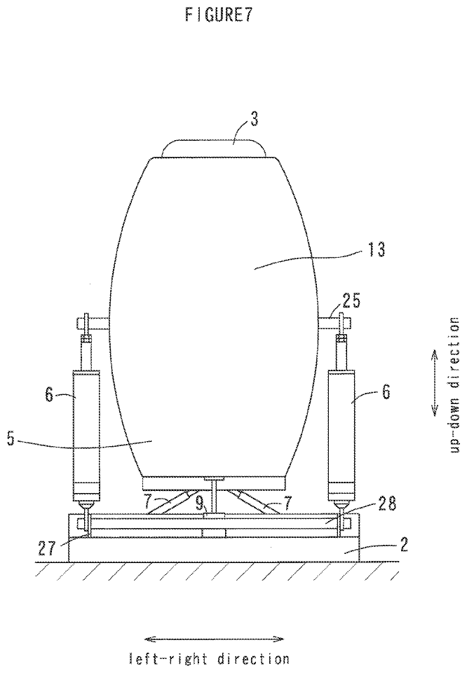

Here, in order to widen the range that the cylinder type actuators 6 and the hood portion 13 do not interfere with each other when the seat support base 5 is tilted to the left or right side, the bar 25 part of the hood portion 13 only needs to have a maximum width in the left-right direction. Therefore, the left and right side surfaces of the hood portion 13 may have a convex curved surface configuration as illustrated in FIG. 7. Note that the convex curved surface configuration has a higher strength against a force from outside than a planar configuration.

Further, a fact that, when the seat support base 5 is tilted to the left or right side, the range that the cylinder type actuators 6 and the hood portion 13 do not interfere with each other can be widened, also means that the cylinder type actuators 6 and the hood portion 13 can be arranged closer to each other, and as a result, the size of the seat support mechanism 1 can be further downsized.

Although the present disclosure has been described in accordance with the exemplary embodiments, it is understood that the present disclosure is not limited to the exemplary embodiment and the structure. The present disclosure also includes various modification embodiments and modifications within an equivalent range. In addition, various combinations and modes, and other combinations and modes including only one element, more elements, or less elements are also within the scope and idea of the present disclosure.

1. A seat support mechanism for a four-wheel vehicle driving simulator comprising:
a base placed on a ground;
a seat support base with a seat being fixed;
a pair of cylinder type actuators that connects the base and the seat support base at two front positions of the seat support base to have a gap between the base and the seat support base, each of the pair of cylinder type actuators having both end portions as universal joints;
a pair of hydraulic dampers that connects the base and the seat support base at two back positions of the seat support base to have a gap between the base and the seat support base, each of the pair of hydraulic dampers having both end portions as universal joints; and
a ball joint that connects the base and the seat support base at a central portion of the seat support base to have a gap between the base and the seat support base.

2. The seat support mechanism for a four-wheel vehicle driving simulator according to claim 1, wherein
each of the pair of cylinder type actuators is arranged perpendicularly to the ground.

3. The seat support mechanism for a four-wheel vehicle driving simulator according to claim 1, wherein
the seat support base, the pair of cylinder type actuators, and the pair of hydraulic dampers are symmetrically arranged.

4. The seat support mechanism for a four-wheel vehicle driving simulator according to claim 3, wherein
the pair of hydraulic dampers is arranged to form an inverted V-shape.

5. The seat support mechanism for a four-wheel vehicle driving simulator according to claim 3, wherein
the ball joint is symmetrically arranged.

6. The seat support mechanism for a four-wheel vehicle driving simulator according to claim 1, wherein
a projection surface of the ball joint to a ground lies within a projection surface of a rectangle formed by connecting coupling portions between the pair of cylinder type actuators and the seat support base and coupling portions between the pair of hydraulic dampers and the seat support base to the ground.

7. The seat support mechanism for a four-wheel vehicle driving simulator according to claim 2, wherein
the seat support base, the pair of cylinder type actuators, and the pair of hydraulic dampers are symmetrically arranged.

8. The seat support mechanism for a four-wheel vehicle driving simulator according to claim 4, wherein the ball joint is symmetrically arranged.

9. The seat support mechanism for a four-wheel vehicle driving simulator according to any one of claim 2, wherein
a projection surface of the ball joint to a ground lies within a projection surface of a rectangle formed by connecting coupling portions between the pair of cylinder type actuators and the seat support base and coupling portions between the pair of hydraulic dampers and the seat support base to the ground.

10. The seat support mechanism for a four-wheel vehicle driving simulator according to any one of claim 3, wherein
a projection surface of the ball joint to a ground lies within a projection surface of a rectangle formed by connecting coupling portions between the pair of cylinder type actuators and the seat support base and coupling portions between the pair of hydraulic dampers and the seat support base to the ground.

11. The seat support mechanism for a four-wheel vehicle driving simulator according to any one of claim 4, wherein
a projection surface of the ball joint to a ground lies within a projection surface of a rectangle formed by connecting coupling portions between the pair of cylinder type actuators and the seat support base and coupling portions between the pair of hydraulic dampers and the seat support base to the ground.

12. The seat support mechanism for a four-wheel vehicle driving simulator according to any one of claim 5, wherein
a projection surface of the ball joint to a ground lies within a projection surface of a rectangle formed by connecting coupling portions between the pair of cylinder type actuators and the seat support base and coupling portions between the pair of hydraulic dampers and the seat support base to the ground.

13. The seat support mechanism for a four-wheel vehicle driving simulator according to any one of claim 7, wherein
a projection surface of the ball joint to a ground lies within a projection surface of a rectangle formed by connecting coupling portions between the pair of cylinder type actuators and the seat support base and coupling portions between the pair of hydraulic dampers and the seat support base to the ground.

14. The seat support mechanism for a four-wheel vehicle driving simulator according to any one of claim 8, wherein
a projection surface of the ball joint to a ground lies within a projection surface of a rectangle formed by connecting coupling portions between the pair of cylinder type actuators and the seat support base and coupling portions between the pair of hydraulic dampers and the seat support base to the ground.
